(19) United States
(12) Patent Application Publication
(10) Pub. No.: US 2002/0143664 A1
(43) Pub. Date: Oct. 3, 2002

(54) Network based gift reminder and purchasing system and method

(76) Inventor: Brett M. Webb, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/825,583

(22) Filed: Apr. 3, 2001

(51) Int. Cl. G06F 17/60

(52) U.S. Cl. 705/27; 705/1

(57) ABSTRACT

A gift reminder and purchasing method comprises tracking gift ideas and related event dates for a user, and notifying the user prior to the event date with a reminder from a gift reminder service provider including at least one network link to a gift merchant web site selling a gift, related to the gift idea wherein the gift merchant web site is not exclusively associated with the gift reminder service provider. A gift reminder and purchasing system comprises a user interface, at least one gift reminder service provider, a gift reminder notification, and a network communication link permitting communication between the user interface, the gift reminder service provider, and the gift merchant site. The gift reminder notification is viewable on the user interface and is generated by the reminder service and includes a network link to a gift merchant web site selling a gift related to the gift idea wherein the gift merchant web site is not exclusively associated with the gift reminder service provider.

### THE FIELD OF THE INVENTION

The present invention relates generally to computer-based reminder services and in particular to computer-based gift reminder services.

### BACKGROUND OF THE INVENTION

Remembering special occasions of friends, families and loved ones through giving gifts greatly enriches our relationships. On the other hand, missing important events can be equally damaging. Fortunately, timely use of calendars enable most people to stay out of trouble.

With the pervasive invasion of computers in our lives, we now have computer-based calendaring and reminder systems. Computerized calendars conveniently provide a perpetual calendar for remembering important events and dates to aid in giving timely gifts. With the advent of the internet, consumers can use Internet-based calendars and reminder services to receive electronic mail reminders of important dates and events.

Nevertheless, remembering the date is not enough. You have to buy a gift. Unfortunately, email reminder services commonly leave the consumer in the same place as they were with paper calendars—without a gift to send. While some reminder services do sell gifts, they typically sell only their own products or sell products from a very small number of retailers that are exclusively associated with the reminder service. Accordingly, only a limited number of choices are available to the consumer for purchasing a gift through the reminder service's web site. This type of service quickly leads to the consumer buying nearly the same type of gift for everyone on the list.

### SUMMARY OF THE INVENTION

A gift reminder and purchasing method of the present invention comprises tracking gift ideas and related event dates for a user, and notifying the user prior to the event date with a reminder from a gift reminder service provider with the reminder including at least one network link to a gift merchant web site selling a gift, related to the gift idea, wherein the gift merchant web site is not exclusively associated with the gift reminder service provider.

A gift reminder and purchasing system of the present invention comprises a user interface, at least network-based gift reminder service provider, a gift reminder notification, and a network communication link permitting communication between the user interface, the gift reminder service, and a gift merchant site. The gift reminder notification is viewable on the user interface and is generated by the gift reminder service provider and includes a network link to a gift merchant web site selling a gift related to the gift idea wherein the gift merchant web site is not exclusively associated with the gift reminder service provider.

### BRIEF DESCRIPTION OF THE DRAWINGS

FIG. 1 is a block diagram of a gift reminder system of the present invention.

FIG. 2 is a block diagram of a home web site of a gift reminder system of the present invention.

FIG. 3 is a flow diagram of a gift reminder system and method of the present invention.

FIG. 4 is a block diagram of a gift reminder notification of a gift reminder system of the present invention.

FIG. 5 is a block diagram of a search result web page of a gift reminder system of the present invention.

FIG. 6 is a block diagram of a gift reminder notification of a gift reminder system of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

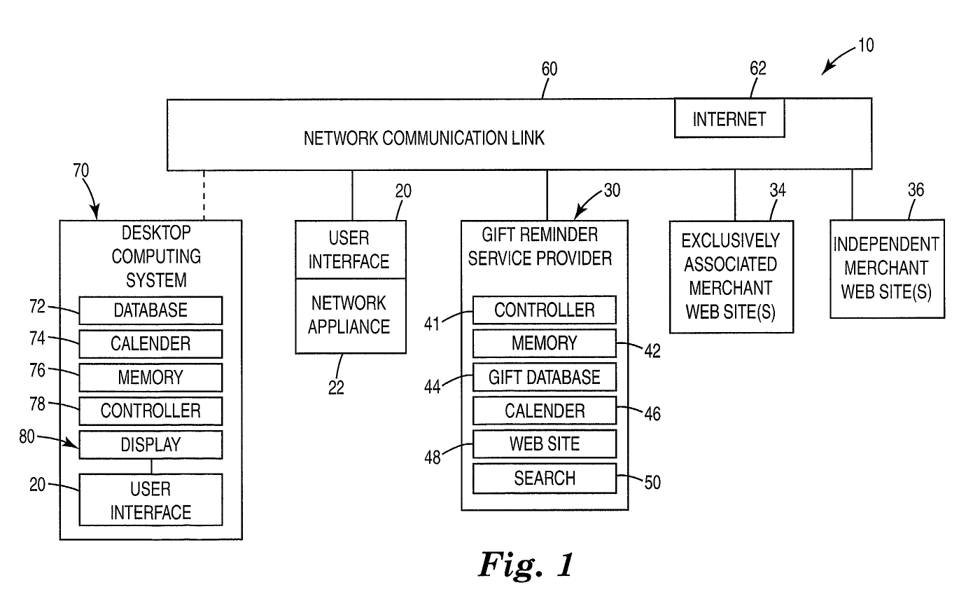

FIG. 1 illustrates one exemplary embodiment of a gift reminder and purchasing system of the present invention generally at 10. A gift reminder and purchasing system according to the present invention enables timely reminders for gift purchasing and simultaneously provides immediate active links to gift merchant web sites permitting wide-ranging choices for gift purchases.

Components of the gift reminder and purchasing system of the present invention can be implemented in hardware via a microprocessor, programmable logic, or state machine, in firmware, or in software within a given device. In one aspect, at least a portion of the software programming is web-based and written in HTML and JAVA programming languages, including links to graphical user interfaces for data collection, such as a windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term computer-readable medium as used herein is defined to include any kind of memory, volatile or non-volatile (e.g., floppy disks, hard disks, CD-ROMs, flash memory, read-only memory (ROM), and random access memory (RAM)).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” Each window has its own adjustable boundaries which allow the user to enlarge or shrink the application or document relative to the display screen. Each window can act independently, including its own menu, toolbar, pointers, and other controls, as if it were a virtual display device. Other software tools may be employed via the window, such as a spreadsheet for collecting data. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

In one embodiment, gift reminder system 10 includes user interface 20 with network appliance 22, gift reminder service provider 30, exclusive gift merchant websites 34 and nonexclusive gift merchant websites 36. Gift reminder service provider 30 further includes system 40, controller 41, memory 42, database 44, calendar 46, web site 48, and search engine 50. Gift reminder system 10 further includes network communication link 60 with Internet link 62, as well as standalone computing system 70 including database 72, calendar 74, memory 76, controller 78, and display 80.

Gift reminder system 10 includes user interface 20 (e.g., a graphical user interface) operating on network appliance 22 and/or on display 80 of stand alone computing system 70 to permit access to web site 48 of gift reminder service provider 30. User interface 20 can be implemented in hardware via a microprocessor, programmable logic device, or state machine, and firmware, or in software within a given device. In one aspect, at least a portion of the software programming is written in Java and HTML programming language, and user interface 20 communicates with gift reminder service provider 30 via network communication link 60 using a communication bus protocol. For example, the present invention optionally can use a TCP/IP protocol suite for data transport. In another aspect, the present invention does not use a TCP/IP protocol suite for data transcript. Other programming languages and communication bus protocols suitable for use with gift reminder system 10 will be apparent to those skilled in the art.

System 40 of gift reminder service provider 30 uses controller 41 that includes hardware, software, firmware or combination of these. In one preferred embodiment controller 41 includes a computer server or other microprocessor based system capable of performing a sequence of logical operation and including memory 42 for storing information. In addition, controller 41 can include a microprocessor embedded systems/appliance incorporating tailored appliance hardware and/or dedicated single purpose hardware. Controller 78 of desktop reminder system 70 has substantially the same features as controller 41.

Calendar 46 of service provider system 40 includes a personal calendar that is a web-centric type calendar accessible through network communication link 60 for tracking dates and events that are personal to the user. Similarly, database 44 is a web-centric type database for tracking gifts, dates, and events in association with calendar 46. Search function 50 is a general Internet search engine as is known in the art, and as will be later described in more detail.

Exclusive gift merchant websites 34 comprise retail websites that have an exclusive fee-for-association contractual relationship with gift reminder service provider 30. In this relationship, gift reminder web site 48 displays gifts sold by gift merchant web site 34 that are available for purchase through gift reminder web site 48, or for purchase directly from gift merchant website 34. The exclusive arrangement insures that users accessing gift reminder web site 48 will be exposed to products from gift merchant web site 34 when the users selects or seeks gifts that are related to products sold by gift merchant web site 34.

In contrast, nonexclusive gift websites 36 comprise retail websites that do not have an exclusive fee-for-association contractual relationship with gift reminder service provider 30. With this arrangement, nonexclusive gift merchant web site 36 operates independently of gift reminder web site 48. Gift merchant web site 36 has no assurance that a user seeking a particular type of gift through gift reminder service provider 30 will be exposed to nonexclusive gift merchant web site 36 that sells that type of gift. Whether the consumer is exposed to nonexclusive gift merchant web site 36 depends solely on whether gift reminder web site 48 identifies site 36 in an Internet search for merchants that sell the type of gift being sought by the user. In this sense, nonexclusive gift merchant web sites 36 are independent of gift reminder service provider 30 and its web site 48. However, gift reminder service provider 30 optionally can charge gift merchant web site 36 a fee for each product from gift merchant web site 36 that is displayed on gift reminder web site 48, or optionally charge a fee for each purchase of a product sold by gift merchant web site 36 that occurs as a result of exposure of the user to gift reminder web site 48. Of course, nonexclusive gift merchant web site 36 would have to give consent to such a fee-for-display or fee-for-purchase arrangement with gift reminder service provider 30.

Both exclusive and nonexclusive gift merchant web sites 34, 36 are not limited to specialized merchants that sell only gift items (e.g., flowers, cards, etc.). Rather, these gift merchant web sites 34, 36 are merchants that sell any type of merchandise or services (e.g. home improvement, clothing, travel vacations, books, music) that could be purchased by a consumer.

Network communication link 60, as used herein, includes an internet communication link, an intranet communication link, or similar high-speed communication link (e.g., the Internet). In one preferred embodiment, network communication link 60 includes an Internet communication link 62. Network communication link 62 permits communication between user interface 20 (via network appliance 22 or standalone computing system 70), gift reminder service provider 30, and gift merchant web sites 34, 36.

Standalone computing system 70 preferably is a microprocessor based desktop computing device but optionally can be embodied in a handheld and/or wireless mobile computing device such as a personal digital assistant or smart mobile phone. Standalone computing system 70 with database 72 and calendar 74 optionally allows the user to maintain their gift ideas and event dates on a calendar and gift database on their own desktop computer (or other standalone computing device). Since calendar 74 is not web-centric, the user need not contact gift reminder service provider 30 via network communication link 60 every time that the user desires to check the status of their personal gift calendar. Accordingly, standalone computing system 70 permits the user to receive the benefits of the gift reminder service provider 30 without having to maintain a always access network communication link between user interface 20 and gift reminder service provider 30 to use database 72 and calendar 74. However, to maintain database 72 and calendars 74 with current gift and calendar information from gift reminder service provider 30, network communication link 60 is periodically used to install updates in standalone computing system 70 from gift reminder service provider 30.

As will be explained in greater detail later in this application, by using system 10, the user may receive a pop-up window notification on user interface 20 (on display 80 of stand alone system 70 or on network appliance 22) of upcoming event dates and associated gift ideas, as well as a link to gift reminder web site 48 and/or gift merchant web sites 34, 36 that sell gifts related to the gift idea. Alternatively, the user optionally receives an electronic mail (email) notification at user interface 20 (on stand alone system display 80 or on network appliance 22) informing the user of the gift idea, event date and a link to gift reminder web site 48 and/or gift merchant web sites 34, 36 that sell gifts related to the gift idea.

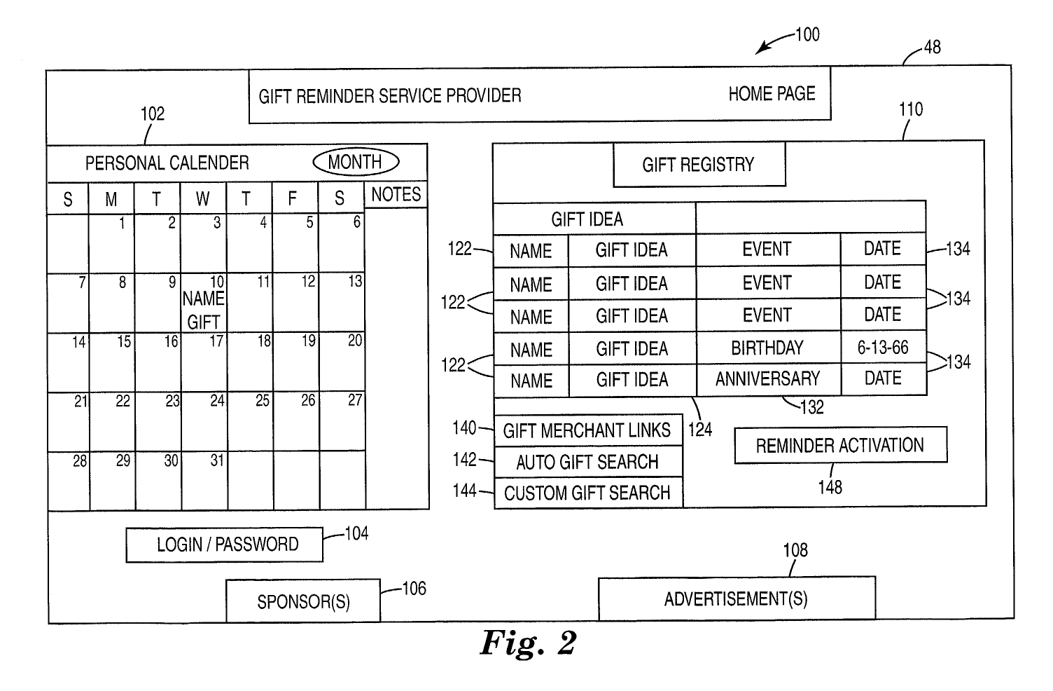

Web site 48 of gift reminder service provider 30 includes home page 100 as shown in FIG. 2. Web site home page 100 is accessed via network communication link 60 through user interface 20 using network appliance 22 or stand alone computing system 70. Web site home page 100 includes personal calendar 102, login function 104, sponsor(s) 106, advertisement 108, and gift registry 110. Gift registry 110 further includes name and gift idea portion 120, event date portion 130, gift merchant links 140, auto gift search function 142, custom gift search function 144, and reminder activation 148.

Home page 100 of service provider web site 48 provides a web-centric location for providing the gift reminder service. Personal calendar 102 displays a monthly, weekly or daily calendar including specific displays of registered event dates and gift ideas unique to the user which are accessed through login/password function 104. To use gift registry 110, names are entered in name function 122, gift ideas are entered in gift idea function 124, and for each event date (e.g. Joe's birthday), events and dates are respectively entered into event function 132 and date function 134.

After this gift idea and event date information is entered, a method of gift searching must be selected. Auto gift search function 142 instructs gift reminder service provider 30 to perform an automatic Internet search for gift merchant web sites 34, 36 in association with a specified gift idea. The search results will be included in the reminder notification as links to gift merchant web sites 34, 36 that sell gifts related to the gift idea. Custom gift search function 144 permits the user to perform a custom gift search either at the time the gift idea is registered, or at a later time when the user receives a gift reminder notification. Gift merchant links function 140 provides links to gift merchant websites 34 that already have a relationship with the gift reminder web site 48. Reminder activation function 148 triggers the registration of all data entered or selected in gift registry 110 for storage into database 44 and memory 42 for later retrieval and for display on calendar 46. When calendar 74 and database 72 of standalone computing system 70 are used to track gifts and event dates, system 70 receives periodic updates of gift and event date information from gift reminder service provider 30. The updates are performed automatically or at the initiation of the user.

In addition, after the gift idea and event date is a registered with the web site 100, the same gift registry information can be downloaded into standalone computing system 70 to permit operation of database 72 and calendar 74 for tracking gifts. Moreover, an executable software module operating substantially similar to gift reminder home page 100 can be downloaded into and operated on standalone computing system 70 to permit use of the method and system of the present invention in an off-line mode. In addition, since user interface 20 on display 80 of standalone computing system 70 optionally has substantially the same appearance, features and attributes of gift reminder web site 48, the gift idea and event date information can first be entered on standalone computing system 70 and then uploaded into gift reminder service web site 48.

Finally, sponsor(s) 106 indicates a retail merchant web site, or other commercial entity that has a fee-for-display arrangement with gift reminder web site 48 for having their name and/or products displayed on the gift reminder web site home page 100. Similarly, sponsor 106 or other entities display advertisement 108 under a fee-for-display arrangement to permit a specific product or service to be offered on gift reminder web site home page 100 to entice users to purchase the product or service advertised. For the convenience of the user and to further entice users to purchase a product or service, advertisement 108 is optionally related to gifts being tracked by gift reminder web site 48. The fees paid by sponsor 106 and owner of advertisement 108 permits the web site 30 to produce revenue, thereby offsetting the cost of providing the gift reminding service, maintaining the database and calendar, etc. Moreover, various mechanisms optionally are arranged with gift merchant websites 34, 36 so that gift reminder service provider 30 receives a fee for each visit, display, transaction, or other interaction between the user and gift merchant websites 34, 36 via gift reminder service provider 30, whether it occurs through gift links 140, auto gift search 142, custom gift search 144, or some other user interaction.

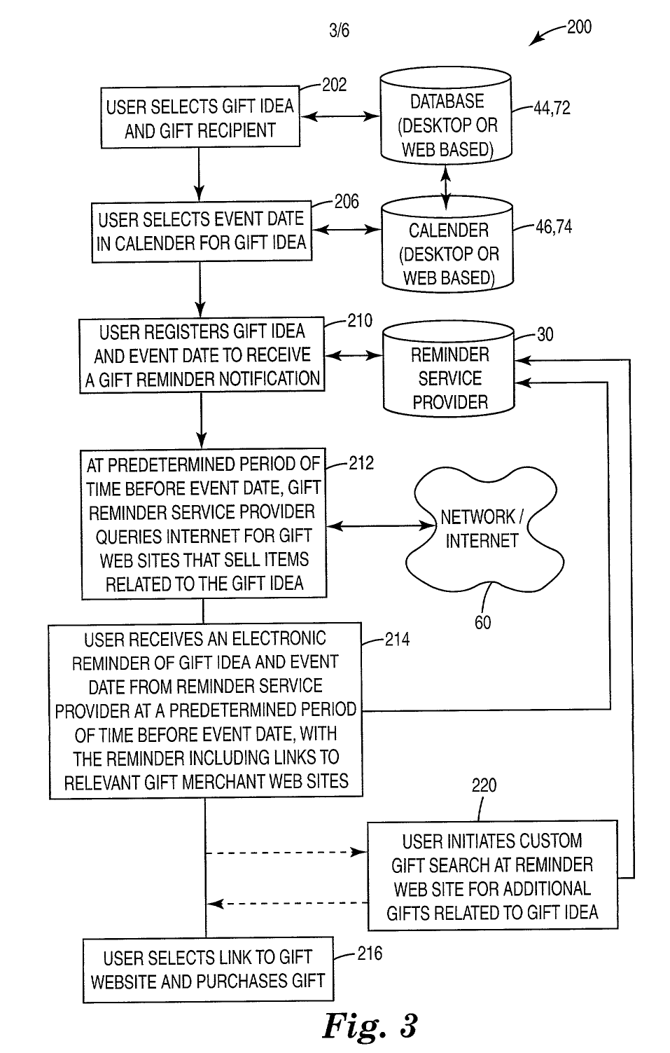

A gift reminder method 200 of the present invention is shown in FIG. 3. In method 200, a user enters or selects gift recipient or name 122 and gift idea 124 using home page 100 while optionally drawing stored gift idea information from database 44, 72 as necessary (step 202). Next, the user enters or selects event 132 and date 134 as an event date, again optionally drawing stored event date information from database 44, 72 and calendars 46, 74 as necessary (step 206). The user then selects reminder activation function 148 to register the gift reminder data into database 44, 72 and calendar 46, 74 so that at a later time the user will receive a timely gift reminder notification from gift reminder service provider 30 (step 210).

At a point in time before the event date, gift reminder service provider 30 uses auto gift search function 142 to perform an Internet search for gift merchant websites 34, 36 that sell gift items related to the gift idea (step 212). The user then receives a reminder notification of the gift idea and event date from gift reminder service provider 30 at a point in time before the event date. The notification comprises either an electronic mail message and/or a pop-up window that appears at user interface 20 (e.g., on display 80 of desktop computing system 70 or network appliance 22). The notification directly or indirectly includes links to gift merchant websites 34, 36 that sell gifts related to the gift idea (step 214). In a final step, the user selects a link to gift merchant website 34, 36 and purchases the gift. If the user is not satisfied with the listing of gift ideas from websites 34, 36 in the reminder notification, then prior to purchasing a gift the user optionally initiates a custom gift search using custom gift search function 144 at gift reminder web site home page 100 to search for additional gifts related to the gift idea (step 220).

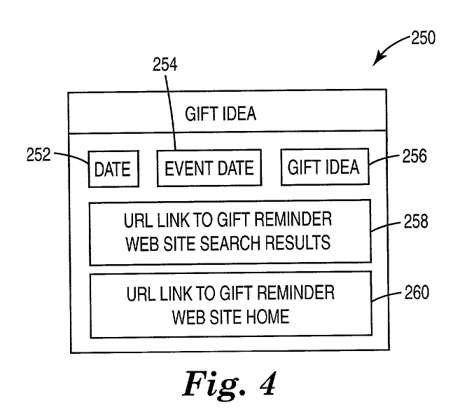

A first gift reminder notification 250 is shown in FIG. 4. In this case, notification 250 preferably appears at user interface 20 (on network appliance 22 or on display 80 of standalone system 70) as a pop-up window. The pop-up window notification 250 enables the user to select a link to gift reminder web site home page 100 or a link to search results generated by gift reminder service provider 30. In particular, as shown in FIG. 4, notification 250 includes date 252, event date 254, gift idea 256, as well as URL (uniform resource locator) link 258 to gift reminder web site search results, and URL link 260 to gift reminder web site home page 100. Upon receiving notification 250, the user selects URL home link 260 to access the general functions of the gift reminder web site 48, or selects URL search result link 258 to view a display of the suggested gifts found in the gift search including links to gift merchants selling those gifts. A connection to network communication link 60 is selectively established to permit activation of the URL links for access to the associated gift merchant websites.

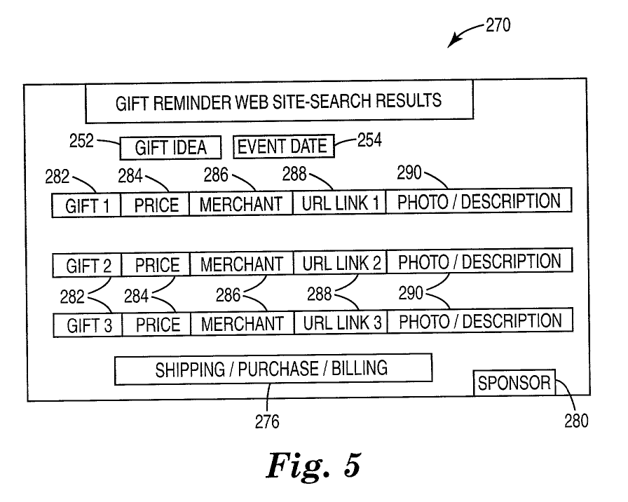

For example, when the search result link 258 is selected, gift search result page 270 is shown to user. As shown in FIG. 5, gift reminder search result page 270 includes gift idea 252, event date 254, itemized gift search results 274, transaction function 276, and sponsor 280. Each itemized search result 274 includes gift 282, price 284, merchant 286, gift merchant URL link 288, and photo/description 290.

The comprehensive information identified in gift reminder search result page 270 permits the user to immediately select one of the URL links 288 associated with each itemized search result 272 to connect the user to the gift merchant websites carrying the suggested gift 282. Alternatively, transaction function 276 permits gift reminder web site 48 to provide shipping, purchase, and common billing functions on behalf of gift merchant web sites 34, 36 to allow the user to complete the transaction at gift reminder web site 48, without directly visiting the merchant gift website 34, 36. A number of electronic transaction services known to those skilled in the art for carrying out transactions between gift merchant web sites 34, 36, 288, gift reminder web site 48, and user interface 20 can be implemented.

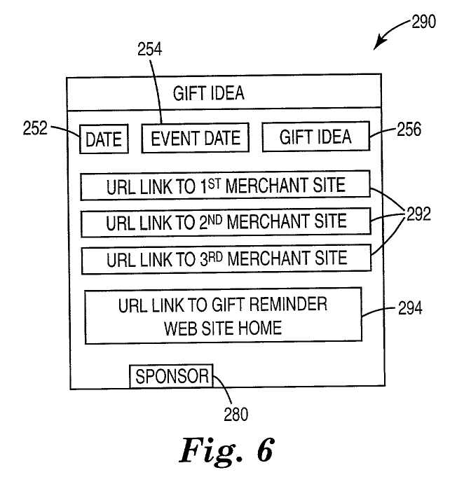

A second reminder notification 290 is shown in FIG. 6 and includes date 252, event date 254, and gift idea 256. Notification 290 includes URL links 292 directly to gift merchant websites 34, 36 that sell the suggested gifts, as well as URL link 294 to gift reminder web site home page 100. Notification 290 further includes sponsor 280. With second notification 290, a user activates URL links 292 to access specific gift merchant websites 34, 36, without first visiting gift reminder web site 48. However, if necessary, URL link 294 permits the user to conveniently visit gift reminder web site home page 100. Second reminder notification 290 optionally includes transaction function 276 which operates substantially as shown and described in FIG. 5.

Accordingly, in response to first or second notification 250, 290, a user can purchase a gift based upon the reminder of the gift idea and event date.

A gift reminder and purchasing method and system of the present invention carries many advantageous features. Foremost, the method and system simultaneously remind a user to get a gift for a specific person by a specific date and provides the means to purchase the gift immediately from the location of the reminder. In particular, the method and system provides the user with at least one link to a gift merchant web site that sells a gift related to a previously determined gift idea of the user. By activating the link, the user can immediately purchase the gift without having to embark on their own search or without having to remember to go to retail store to buy the gift. Remembering that a gift is needed is only part of gift giving. This system and method will help users succeed in the exact place that most fail in gift giving: actually buying the gift.

Moreover, unlike prior attempts at gift reminder services, the method and system according to the present invention permits wide-ranging choices in the type of gift given.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of gift purchasing comprising:
tracking gift ideas and related event dates for a user; and
notifying the user prior to the event date with a reminder from a gift reminder service provider with the reminder including at least one network link to a gift merchant web site selling a gift related to the gift idea wherein the gift merchant web site is not exclusively associated with the gift reminder service provider.

2. The method of claim 1, wherein the tracking step comprises:
displaying the gift ideas and event dates on a web site of the gift reminder service provider.

3. The method of claim 1, further comprising:
supplying the reminder service through a gift reminder web site and providing the network link as a uniform resource locator for the gift merchant web site.

4. The method of claim 1, wherein the notifying step further comprises:
providing the network link as a link to the gift reminder web site at which the user will obtain a plurality of network links to independent gift merchant web sites that sell gifts related to the gift idea.

5. The method as in claim 4, and further comprising:
displaying at the gift reminder web site a listing of gifts related to the gift idea with each respective gift listing including a price, a description, and a uniform resource locator address.

6. The method of claim 1, wherein the notifying step further comprises:
delivering the reminder to the user as an electronic mail notification from the gift reminder service provider through the user interface.

7. The method of claim 1, wherein the notifying step further comprises:
obtaining the link from an internet search initiated by the gift reminder service provider for web sites that sell gifts related to the gift ideas.

8. The method of claim 1, wherein the notifying step further comprises:
delivering the reminder to the user as a pop-up window from a standalone computing system that is in selective communication with the gift reminder service provider.

9. A computer-based gift purchasing system comprising:
a user interface;
at least one network-based reminder service provider;
a notification viewable on the user interface that is generated by the reminder service provider and including a network link to a gift merchant web site selling a gift related to the gift idea wherein the gift merchant web site is not exclusively associated with the reminder service provider; and
a network communication link permitting communication between the user interface, the reminder service provider, and the gift merchant web site.

10. The system of claim 9, wherein the notification further comprises:
at least one of an electronic mail message listing the network link and a desktop-based pop-up window listing the network link.

11. The system of claim 9, wherein the notification further comprises:
a link to the gift reminder web site that includes a listing of a plurality of network links to independent merchant web sites that sell gifts related to the gift idea.

12. The system of claim 9, wherein the notification further comprises:
a plurality of active network links to independent merchant web sites that sell gifts related to the gift idea.

13. The system of claim 12, further comprising:
a gift detail display mechanism for displaying each gift merchant web site link, a gift listing including a gift related to the gift idea, a price, a description, and a uniform resource locator address to the gift merchant web site.

14. The system of claim 9, further comprising:
a gift registry database of the gift reminder service provider; and an event date database and calendar system of the gift reminder service provider.

15. A computer-based electronic gift reminder notification system comprising:
a gift reminder service provider;
a display window on a user interface listing a gift idea and an event date; and
a message in the display window received from the gift reminder service provider at a point in time prior to the event date and that includes a network link to a gift merchant web site that is independent of the gift reminder service provider and that sells gifts related to the gift idea.

16. The system of claim 15, wherein the message further comprises:
at least one of an electronic mail message and a pop-up window message.

17. The system of claim 15, wherein the message further comprises:
a text message identifying a gift idea, an event date, a gift recipient, a gift, a price, and the network link includes at least one uniform resource locator link to the gift merchant web site.

18. A method of gift purchasing comprising:
tracking gift ideas and related event dates for a user; and
notifying the user at a point in time prior to the event date with an electronic mail reminder from the gift reminder service provider with the reminder including at least one network link to a gift merchant web site selling a gift related to the gift idea wherein the gift merchant web site is independent of the gift reminder service provider.

19. A method of gift purchasing comprising:
receiving an electronic reminder notification from a gift reminder service provider of an event date and a gift idea for a gift recipient prior to the event date with the notification including at least one network link to a gift merchant web site selling a gift related to the gift idea wherein the gift merchant web site is independent of the gift reminder service provider; and
purchasing a gift for the gift recipient by activating the link to the gift merchant web site.

20. A computer-readable medium having computer-executable instructions for performing a method of gift purchasing, the method comprising:
tracking gift ideas and related event dates for a user; and
notifying the user prior to the event date with a reminder from a gift reminder service provider with the reminder including at least one network link to a gift merchant web site selling a gift related to the gift idea wherein the gift merchant web site is not exclusively associated with the gift reminder service provider.
